(19) United States
(12) Patent Application Publication
(10) Pub. No.: US 2025/0278380 A1
(43) Pub. Date: Sep. 4, 2025

(54) METHOD AND APPARATUS FOR XPU INTEGRATION SCALING WITH ARTIFICIAL INTELLIGENCE BRIDGE CHIPLETS

(71) Applicant: Jawad Nasrullah, Palo Alto, CA (US)

(72) Inventor: Jawad Nasrullah, Palo Alto, CA (US)

(21) Appl. No.: 18/945,422

(22) Filed: Nov. 12, 2024

Related U.S. Application Data
(60) Provisional application No. 63/559,765, filed on Feb. 29, 2024.

(51) Int. Cl. G06F 13/40

(52) U.S. Cl. CPC G06F 13/409; G06F 13/4068

(57) ABSTRACT

A first bridge apparatus comprising a connector circuit having a first interface to communicate with a processor die and a second interface to communicate with a stack of memory dies such that the processor die and the stack of memory dies are vertically adjacent to the connector circuit which bridges the processor die and the stack of memory dies. The first bridge apparatus further comprises a first connector link circuitry and a second connector link circuitry coupled to the connector circuit, wherein the connector circuit is a network-on-chip connector circuit. The first connector link circuitry is to communicate with a third connector link of a second bridge apparatus and the second connector link circuitry is to communicate with a fourth connector link of a third bridge apparatus.

### CLAIM OF PRIORITY

This application claims priority to U.S. Provisional Patent Application No. 63/559,765, filed Feb. 29, 2024, and titled “Method and Apparatus for XPU Integration Scaling with AI Bridge Chiplet,” which is incorporated by reference in its entirety.

### BACKGROUND

The width, depth, and complexity, defined by the number of parameters of generative artificial interference (AI) models are exponentially growing. As a result, the ability to create more compute power in less space of silicon, without compromising the performance, is becoming valuable. But limitations in the lithography technology to fabricate such silicon systems are becoming a bottleneck to achieve the desired capability.

The background description provided here is for the purpose of generally presenting the context of the disclosure. Unless otherwise indicated here, the material described in this section is not prior art to the claims in this application and is not admitted to be prior art by inclusion in this section.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIG. 1 is a schematic illustrating a side view of an assembly of artificial interference (AI) bridge chiplets on a substrate, in accordance with at least one example.

FIG. 2 is a schematic illustrating a top view of an assembly of AI bridge chiplets on a substrate with the top surface having pads for processor dies and stacks of memory dies, in accordance with at least one example.

FIG. 3 is a schematic illustrating a side view of an assembly of AI bridge chiplets on a substrate with processor dies and stacks of memory dies connected via AI bridge chiplets, in accordance with at least one example.

FIG. 4 is a schematic of an AI bridge chiplet with the top surface having pads for processor dies and stacks of memory dies and bottom surface having input-output (IO) connections to bond with the substrate, in accordance with at least one example.

FIG. 5 is a schematic of a circuitry of an AI bridge chiplet using active silicon transistors and front-end devices, in accordance with at least one example.

FIG. 6 is a schematic of a circuitry of an AI bridge chiplet in which a processor die and a stack of memory dies are bridged via a connector circuit, in accordance with at least one example.

FIG. 7A is a schematic illustrating a top view of an assembly of AI bridge chiplets on a substrate in which a plurality of processor dies and stacks of memory dies are bridged via a plurality of connector circuits, wherein the AI bridge chiplets are connected in a ring configuration, in accordance with at least one example.

FIG. 7B is a schematic illustrating a top view of an assembly of AI bridge chiplets on a substrate in which processor dies and stacks of memory dies are bridged via a plurality of connector circuits, wherein the AI bridge chiplets are connected in a grid configuration, in accordance with at least one example.

FIG. 8 is a schematic illustrating an isometric-view of an assembly of AI bridge chiplets on a substrate with processor dies and stacks of memory dies, in accordance with at least one example.

FIG. 9 is a flowchart of a boot-up sequence for an AI bridge chiplet within an assembly of AI bridge chiplets, in accordance with at least one example.

### DETAILED DESCRIPTION

Disclosed herein is an active silicon-based bridge chiplet comprising a connector circuit, having a first interface to communicate with a processor die and a second interface to communicate with a stack of memory dies. In at least one example, the processor die and the stack of memory dies are vertically adjacent to the connector circuit which bridges the processor die and the stack of memory dies. The active silicon-based bridge chiplet (e.g., an AI bridge chiplet) further comprises of a first connector link circuitry and a second connector link circuitry coupled to the connector circuit, wherein the first connector link circuitry is to communicate with a third connector link of a second bridge chiplet and the second connector link circuitry is to communicate with a fourth connector link of a third bridge chiplet.

In at least one example, the connector circuit is a network-on-chip (NOC) connector circuit. In at least one example, a first connector link circuitry and a second connector link circuitry are NOC connector link circuitries coupled to an NOC connector circuit. In at least one example, the first connector link circuitry and the second connector link circuitry are die-to-die connector link circuitries.

In at least one example, an AI bridge chiplet comprises two connector link circuitries e.g., a first connector link circuitry and a second connector link circuitry. In at least one example, an AI bridge chiplet comprises four connector link circuitries e.g., a first connector link circuitry, a second connector link circuitry, a third connector link circuitry and a fourth connector link circuitry.

In at least one example, an AI bridge chiplet may have pads on its top surface to connect a processor die and a stack of memory dies, and its bottom surface may have IO connections to bond with a substrate. The substrate can be a passive substrate, an active substrate, an interposer, etc. In at least one example, an AI bridge chiplet may act as a full chiplet that includes communication, control, and test circuitry, in addition to serving as a stacking base die for the processor die and the stack of memory dies. In at least one example, AI bridge chiplets feature integrated functionalities including: (a) bridging processor dies and stacks of memory dies via connector circuits; (b) enabling connectivity between processor dies and stacks of memory dies using switches; (c) interconnectivity between various AI bridge chiplets; (d) testability; (c) bootup sequencing; and/or (f) voltage regulation and/or power gating, etc.

At least one example discloses a network of AI bridge chiplets that bridges processing units and high-bandwidth memory (HBMs), wherein the AI bridge chiplets, within the network of AI bridge chiplets, may be connected in a ring configuration or a grid configuration. AI bridge chiplets within the network of AI bridge chiplets can be added or removed based on envisioned use cases. At least one example makes it easy to scale a network of AI bridge chiplets by increasing the size of the supporting substrate and mounting on additional AI bridge chiplets. In at least one example, a network of AI bridge chiplets can provide improved energy efficiency which may address one of the primary concerns in scaling AI bridge chiplets. In at least one example, scaling can be done in x-dimension and/or y-dimension.

In at least one example, an integration of silicon-based bridge chiplet can be an economical choice, as it can reduce the cost of AI bridge chiplets, for example, by approximately 30%. The cost of manufacturing conventional silicon interposer-based XPU integration is typically higher due to additional material and processing costs. AI bridge chiplet integration, in comparison, can eliminate the need for a silicon interposer, and reduces the bill of materials (BOM) for high-bandwidth memory (HBM) stacks. In at least one example, AI bridge chiplets may also function as an individual platform that can allow for stacking pre-packaged processors and HBMs, to meet tighter delivery deadlines by the manufacturing industry, as AI bridge chiplets can facilitate a rapid deployment and integration without using extensive and new fabrication processes.

Here, “XPU” may generally refer to a processing unit such as a central processing unit (CPU), a graphics processing unit (GPU), a data processing unit (DPU), a neural processing unit (NPU), an application specific integrated circuit (ASIC), or any other processing unit.

Here, “chiplet” or “dielet” may generally refer to an integrated circuit (IC) or a die that is designed to operate as part of a larger system-on-chip (SoC) architecture. Instead of creating a complete custom chip from scratch, manufacturers can use multiple chiplets or dies, each designed for specific functions, and integrate them into a single package or die. Chiplets allow for modular design, which can improve efficiency and reduce manufacturing costs. This approach also provides flexibility, as different chiplets can be combined in various configurations to meet the demands of different applications. Chiplets can provide various functions, including processing cores, memory controllers, or specific I/O functionalities. Chiplets can be used in high-performance computing and edge devices, as they enable quicker time to markets, as a new architecture can be configured, by selecting chiplets and dynamically arranging them in a topology, to create optimized solutions.

Here “bridges” may generally refer to specialized components that can connect different segments or components of a system, which may allow for efficient communications and data transfers between different segments or components. In at least one example, bridges can facilitate interaction between disparate parts of a circuit, such as between different chiplets or cores, ensuring that information can flow seamlessly across the entire architecture. Bridges can be used for coordinating activities and managing data traffic, contributing to the overall efficiency and functionality of complex systems.

Here, “AI bridges” may generally refer to bridges used for coordinating activities and managing data traffic, contributing to the overall efficiency and functionality of complex systems suited for artificial intelligence and machine-learning. AI bridges may also be used for less complex systems such as ASICs and CPUs.

Here, “die” may generally refer to a single continuous piece of semiconductor material (e.g. silicon) on which transistors or other components that make up a processor core can be etched. Multi-core processors may have two or more processors on a single die, but alternatively, the two or more processors may be etched on two or more respective dies. In some instances, like with symmetric codes, the dies may be of the same size and have similar functionality, while in case of asymmetric cores the size of dies or functionality may differ across cores.

Here, “interconnects” may generally refer to electrical wiring either of or in integrated circuits that facilitates communication between different components, e.g., chiplets, dielets, dies, nodes, processors, circuits, or functional blocks. An interconnect may be a communication link between two or more components or nodes. Interconnects can enable the transfer of signals, data, and power across a system, ensuring that components can efficiently and effectively work together. The configuration of interconnects significantly influences the performance, speed, and reliability of an overall circuit. Interconnects can include conduction paths such as a fabric, passive or active components, wires, vias, waveguides, fiber optics, etc.

In the following description, numerous details are discussed to provide a more thorough explanation of examples of the present disclosure. It will be apparent, however, to one skilled in the art, that examples of the present disclosure may be practiced without these specific details. In other instances, well-known structures and devices are shown in block diagram form, rather than in detail, to avoid obscuring examples of the present disclosure.

Note that in the corresponding drawings of the examples, signals are represented with lines. Some lines may be thicker, to indicate multiple constituent signal paths, and/or have arrows at one or more ends, to indicate primary information flow direction. Such indications are not intended to be limiting. Rather, the lines are used in connection with one or more exemplary examples to facilitate easier understanding of a circuit or a logical unit. Any represented signal, as dictated by design needs or preferences, may actually comprise one or more signals that may travel in either direction, and may be implemented with any suitable type of signal scheme.

It is pointed out that those elements of the figures having the same reference numbers (or names) as the elements of any other figure can operate or function in any manner like that described but are not limited to such.

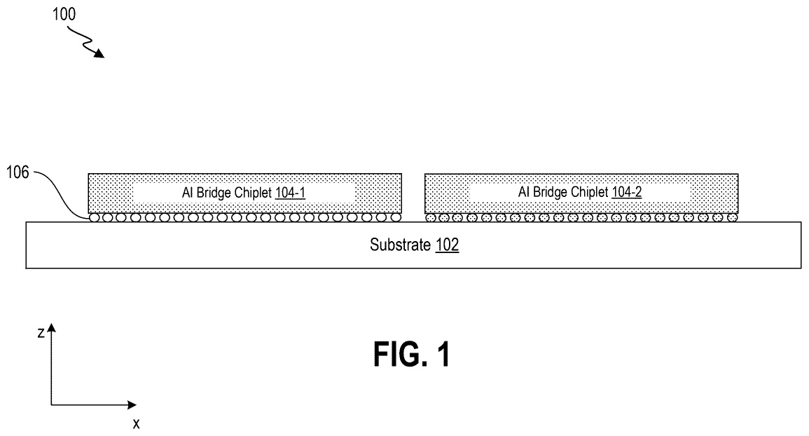

FIG. 1 is a schematic illustrating a side-view of an assembly of AI bridge chiplets on a substrate, in accordance with at least one example. For a system such as generative AI that is driving an ever-increasing demand in compute power, many processing units and memory stacks may be used. Packages such as 2.5D and 3D that combine processing units with high-bandwidth memory (HBM) stacks can be used for enhancing the performance of AI applications by increasing the data transfer rates using on-chip high-speed communication networks.

The tight coupling of processing units and HBM stacks can offer significant performance benefits, but also limits the potential for further enhancement to individual components, namely the processing units and the HBM stacks. For instance, any future improvements in processing power or memory speed might need a complete redesign of the entire packaging technology, which can be not only time-consuming but also expensive. Thus, this interdependence can complicate the upgrade path and may hinder the rapid advancements that are needed to process evolving and increasing AI workloads. Moreover, the integration of components e.g., processing units and HBM stacks are further limited by the size of silicon interposers, which typically accommodate merely 8 to 12 HBM stacks. Interposers larger than 60 mm×60 mm often face issues related to manufacturing because of lithography limitations and warpage during production, which can impede the efficient integration of multiple processing units and memory stacks.

Described herein is a method and apparatus to replace silicon interposer with small active silicon-based bridge chiplets that bridge processing units and memory stacks. At least one example discloses a network of active silicon-based bridge chiplets (e.g., AI bridge chiplets) that can integrate processing units and can stack ICs in vertical dimensions e.g., a memory stack, allowing AI bridge chiplets within the assembly of AI bridge chiplets to communicate with adjacent neighboring AI bridge chiplets.

The assembly of AI bridge chiplets 100 can house multiple AI bridge chiplets 104-1 and 104-2 on a substrate 102, which can be collectively referred to as AI bridge chiplets 104 and can be individually referred to as AI bridge chiplet 104. AI bridge chiplets 104 are small, functional units that can be integrated onto a large underlying carrier (e.g., a substrate, an IC package, a printed circuit board, or the like) to create a scalable assembly. In contrast, traditional integrated circuits, designed to support generative AI workloads, combine all the functions on a single large chip, whereas AI bridge chiplets may allow for a modular approach such that the assembly of AI bridge chiplets 100 becomes easy to scale. Additionally, for generative AI applications, where workloads can vary significantly, AI bridge chiplets 104 can be tailored and customized to handle specific tasks and can reduce the processing burden on any single component.

In at least one example, AI bridge chiplets 104 are active silicon-based bridge chiplets placed on an active silicon die. The active silicon die can perform computations and can provide the overall functionality of an AI bridge chiplet 104. In at least one example, AI bridge chiplets 104, as active silicon dies, comprises active components (e.g., processors, controllers, memory etc.), which can be useful in high-performance applications e.g., data processing or generative AI. In at least one example, AI bridge chiplets 104 may act as a full chiplet having a built-in circuitry that may also feature integrated functionalities.

In at least one example, substrate 102 or interposer may serve as the foundation layer that facilitates the integration and interconnection of AI bridge chiplets 104 within the assembly of AI bridge chiplets 100. In at least one example, substrate 102 can be an organic substrate that is lightweight and flexible. The organic substrate can be made up of materials e.g., polyimide or FR-4 that are cost-effective. The organic substrate may provide interconnectivity between the AI bridge chiplets 104 by embedding conductive traces, allowing for routing electrical signals across the surface of the organic substrate and to enable communication between the AI bridge chiplets 104 mounted on substrate 102. In at least one example, AI bridge chiplets 104 are mounted on an inorganic substrate that can offer high thermal stability and mechanical support. The inorganic substrate can be made up of ceramic, glass, and/or silicon.

In at least one example, substrate 102 can be high-density laminates that may be widely used due to their flexibility and cost-effectiveness. High-density laminates are composite materials that are generated by layering epoxy resin with reinforcing fibers, allowing for fine-pitch interconnections that are used for high-performance applications. In at least one example, printed circuit boards (PCBs) may serve as substrate 102 to assemble multiple AI bridge chiplets 104. PCBs are a form of substrate 102 made from rigid materials and comprise layers of copper traces etched onto the PCB. The copper traces create pathways for electrical connections and also provide mechanical support to the PCB. In at least one example, a single substrate can be used that incorporates one layer of interconnects. In at least one example, multiple substrates can be stacked, each with its own layer of interconnects with an enhanced connectivity in a compact space. For example, the organic substrate may be stacked over a PCB, where enhanced interconnectivity is needed. In at least one example, the organic substrate may integrate the AI bridge chiplets 104 and the PCB may serve as the primary support structure for the assembly of AI bridge chiplets 100.

Substrate 102 may facilitate the integration of AI bridge chiplets 104. For instance, substrate 102 may use interconnect technologies e.g., solder balls, copper pillars or through-silicon-vias (TSVs) to establish reliable connection between substrate 102 and AI bridge chiplets 104. In at least one example, AI bridge chiplets 104 comprises solder balls 106 (also referred to as solder bumps) or copper pillars as interconnects to mount AI bridge chiplets 104 on substrate 102. In at least one example, solder balls 106 are small spheres that can align with the pads on substrate 102. Solder on the solder balls 106 can be melted to form an electrical and mechanical bond between AI bridge chiplets 104 and substrate 102. In at least one example, solder balls 106 may allow for dense arrangement of the AI bridge chiplets 104. In at least one example, solder balls 106 may help dissipate thermal energy and prevent AI bridge chiplets 104 from overheating. In at least one example, interconnects between AI bridge chiplets 104 and substrate 102 can be copper pillars. Copper pillars are copper-based cylindrical structures that serve similar purpose as solder balls 106. In at least one example, copper pillars are useful for power demanding applications, as copper pillars can sustain high current loads. In at least one example, copper pillars can also enable fine pitch interconnects that may allow for a compact design. In addition to solder balls 106 or copper pillars, TSVs may be utilized as interconnects. In at least one example, TSVs may serve as vertical interconnects that may allow direct communication between different layers of substrate 102. For example, TSVs may enable communication between an organic substrate and a PCB. In at least one example, TSVs may reduce signal delays and improve power efficiency. However, the choice of substrate 102 or the level of interconnects may not be considered as limiting the scope of various examples.

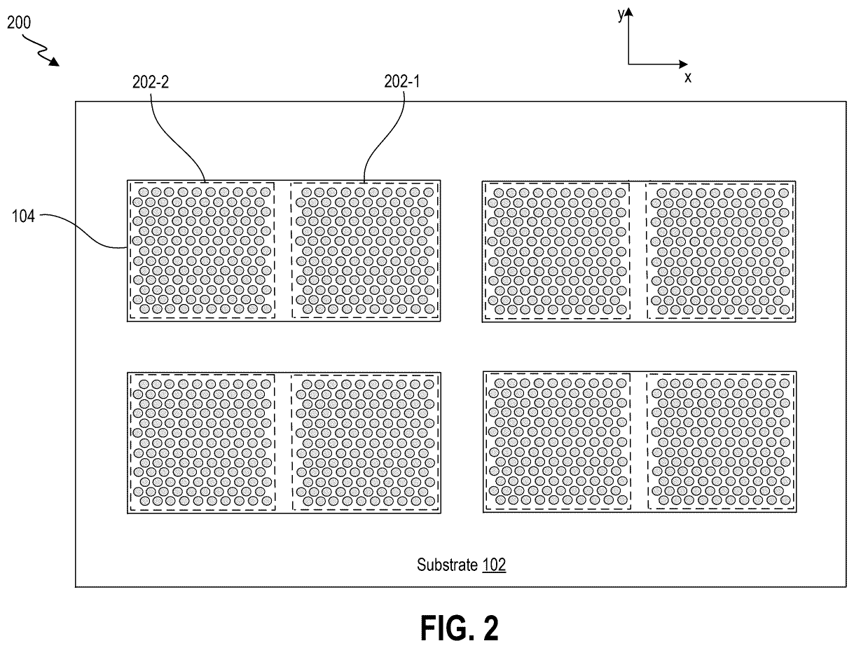

FIG. 2 is a schematic illustrating a top view of an assembly of AI bridge chiplets on a substrate on which the top surface has pads for processor dies and stacks of memory dies, in accordance with at least one example. Pads may serve as contact points for solder balls 106, solder bumps, solder micro bumps, copper pillars, or other interconnects. In at least one example, pads may be flat, conductive areas to provide a surface for a connection. In at least one example, pads may enable electrical communication between components (e.g., processors dies and stack of memory dies).

One such example is illustrated in FIG. 2, where two separate pads are designed onto the top surfaces of AI bridge chiplets 104. Pad 202-1 of AI bridge chiplet 104 may be a processor pad, and pad 202-2 of the AI bridge chiplet 104 may be a memory pad that can be individually referred to as pad 202 and can be collectively referred to as pads 202. In at least one example, pad 202-1 may be a memory pad and pad 202-2 may be a processor pad. In at least one example, one of the two pads 202 may be used to connect a processor die, while the other may be used to connect the stack of memory dies.

In at least one example, processor pads may be dedicated conductive areas on AI bridge chiplets 104 designed to connect processor dies. The processor pads may provide high-speed communication with the stack of memory dies and allow the processor dies to execute tasks efficiently. In at least one example, memory pads may be specifically intended for connecting stack of memory dies onto AI bridge chiplets 104. In at least one example, memory pads may enable the transfer of data to and from the memory dies and may allow processor dies to access information in the memory dies for processing tasks. In at least one example, processor pads and memory pads may feature solder bumps or solder micro bumps to create a reliable connection for communication.

In at least one example, communication between processor pads and memory pads may occur through a circuitry built inside AI bridge chiplets 104, which configures interconnections as deemed necessary. For example, when a processor die requires data or information, a request can be sent from a processor pad to a memory pad. The request propagates along the interconnect pathways on AI bridge chiplets 104, allowing a stack of memory dies to respond by sending the data or information to the processor die via the processor pad and memory pad. In at least one example, the connection established by AI bridge chiplets 104 may enable the processor dies to access or manipulate the stored data in a stack of memory dies through the interconnect pathways connecting pads.

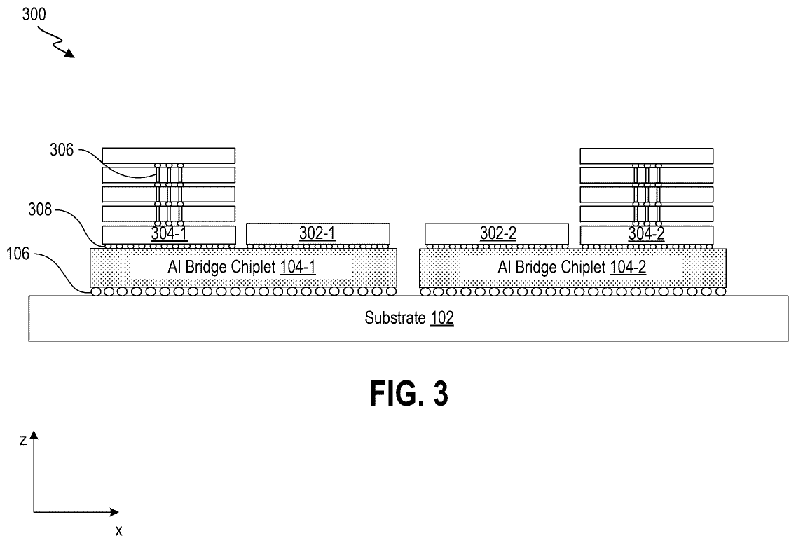

FIG. 3 is a schematic illustrating a side-view of an assembly of AI bridge chiplets on a substrate on which processor dies and stacks of memory dies connected via AI bridge chiplets, in accordance with at least one example. Assembly of AI bridge chiplets 200 illustrates designated pads 202 on AI bridge chiplets 104. Pads 202 are utilized to connect processor dies and stack of memory dies. One such example is illustrated in FIG. 3, where processor dies 302-1, 302-2 that can be collectively referred to as processor dies 302 and can be individually referred to as processor die 302. Similarly, a stack of memory dies 304-1, 304-2 that can be collectively referred to as stacks of memory dies 304 and can be individually referred to as a stack of memory dies 304. In at least one example, processor dies 302 and stacks of memory dies 304 may be connected onto AI bridge chiplets 104 using solder micro bumps.

In at least one example, solder micro bumps 308 can provide reliable electrical links between dies (e.g., processor dies 302 and stack of memory dies 304) and AI bridge chiplets 104. In at least one example, solder micro bumps 308 may allow for tight spacing between dies and AI bridge chiplets 104, which may be beneficial in high density applications (e.g., generative AI). In at least one example, solder micro bumps 308 may connect processor dies 302 and stacks of memory dies 304 that are in proximity to minimize or reduce signal propagation delays that improve the overall performance of the system. In at least on example, solder micro bumps 308 may enable high-bandwidth communication between processor dies 302 and stacks of memory dies 304, contributing to an efficient execution of applications.

In at least one example, AI bridge chiplets 104 are connected to substrate 102 using solder balls 106 (also referred to as solder bumps). Solder bumps may enable reliable communication between AI bridge chiplets 104 and substrate 102. In at least one example, AI bridge chiplets 104 within the assembly of AI bridge chiplets 300 can maintain signal integrity between processor dies 302 and stacks of memory dies 304. In at least one example, AI bridge chiplets 104 can provide interconnectivity and allow different dies (e.g., a processor die 302 and a stack of memory dies 304) to communicate with each other. In at least one example, AI bridge chiplets 104 may allow for heterogeneous integration. In at least one example, AI bridge chiplets 104 can operate on level shifting to accommodate differences in voltage levels between dies. AI bridge chiplets 104 may enable dies, operating at different voltage levels, to interact. In at least one example, AI bridge chiplets 104 can optimize data routing by determining the most efficient path for data transmission, thereby reducing latency.

In at least one example, processor dies 302 and stacks of memory dies 304 are mounted on AI bridge chiplets 104, wherein processor die 302 may be a piece of silicon on which microprocessor may be fabricated, and stacks of memory dies 304 may be an assembly of two or more pieces of silicon stacked and bonded in a single package. In at least one example, processor die 302 may function as a central processing unit (CPU) for general-purpose computing tasks, managing system resources, and executing instructions. In at least one example, CPU may serve as a backbone for many AI applications. In at least one example, CPU may typically be well suited to process algorithm-intensive tasks that may not support parallel processing. CPUs may also help to orchestrate the overall functionality of a system.

In at least one example, graphic processing units (GPUs) may excel in generative AI tasks that can function as a processor die 302. In at least one example, GPUs may have a high compute power. GPUs carry the ability to process thousands of threads simultaneously that can be effective for tasks related to deep learning models, such as convolutional neural networks (CNNs) and recurrent neural networks (RNNs), which can be widely used in applications ranging from image and speech recognition to natural language processing. In at least one example, GPUs can significantly enhance the performance of generative AI applications through accelerated processing capabilities. For example, popular frameworks e.g., TensorFlow and PyTorch leverage GPU acceleration to enhance the training speed of AI models.

In at least one example, processor die 302 may function as a data processing unit (DPU). DPUs may become increasingly relevant in data-centric AI workloads that involve handling massive datasets for tasks such as training machine learning models, analyzing patterns, and optimizing data flows. In at least one example, DPUs may be used to offload data processing tasks from CPUs and enable faster and more efficient handling of data. In at least one example, DPUs can manage data traffic, perform preprocessing and optimize data movement, which can further reduce latency.

In at least one example, processor dies 302 may function as neural processing units (NPUs). NPUs are specifically engineered to accelerate generative AI workloads, particularly in neural network processing. In at least one example, NPUs are optimized for tasks e.g., inference and model training that can make NPUs suitable for generative AI applications. Devices equipped with NPUs, such as Google's Tensor Processing Units (TPUs) and specialized AI chips from companies like Apple (e.g., the A-series chips in iPhones) and Huawei showcase the ability to perform complex AI computations by consuming relatively smaller energy.

In at least one example, processor dies 302 on AI bridge chiplets 104 may be functionally similar. In at least one example, processor dies 302 on AI bridge chiplets 204 can be functionally different. For example, processor die 302 on AI bridge die 104-1 may function as a GPU and one on AI bridge chiplet 104-2 functions as an NPU. In at least one example, processor dies 302 can be created to meet unique application requirements (e.g., generative AI applications). In at least one example, already packaged or pre-made processors can be used as processor dies 302. For example, Xeon processors by Intel that are widely used in data centers for handling enterprise workloads, EPYC processors by AMD, NVIDIA H100 Tensor Core GPUs are also pre-packaged for AI applications. Similarly, Google's TPUs are available as a packaged solution specifically designed for accelerating machine learning workloads. However, the choice of processor dies 302 may not be limiting the scope of various examples.

In addition to processor dies 302, stacks of memory dies 304 are also mounted on AI bridge chiplets 104. Stacks of memory dies 304 may comprise multiple memory dies that can be stacked vertically to save space. In at least one example, stacks of memory dies 304 may function as dynamic random access memory (DRAM) stacks. DRAM stacks can be used in generative AI workloads to provide necessary temporary data storage for running complex applications. In at least one example, DRAM provides high-speed access for efficient handling of large datasets that may be essential when training models or processing real-time data. In at least one example, DRAM may enable seamless multitasking and quick response times for generative AI applications. In at least one example, stacks of memory dies 304 can be HBM DRAM stacks (also referred as HBM DRAM). In at least one example, HBM DRAM may offer higher bandwidth compared to DRAM stacks. In at least one example, HBM utilizes a 3D stacking architecture and wide interfaces to provide faster data transfer rates, which can make HBM DRAM particularly suitable for applications demanding high memory bandwidth e.g., graphics processing and AI workloads.

Within a stack of memory dies 304, memory dies are stacked to form a single package. Memory dies comprise memory cells that may be organized in a grid format. In at least one example, memory dies within stack of memory dies 304 are interconnected through-silicon vias (TSVs) that are vertical conduits that may pass through individual memory dies. In at least one example, TSVs can transfer signals between memory dies within stack of memory dies 304 that may allow for high-speed communication and can also minimize latency. The vertical integration may not only save space but also enhances bandwidth, which can enable faster access to data across multiple layers of stack of memory dies 304.

In at least one example, a stack of memory dies 304 can be created to meet unique application requirements (e.g., generative AI applications). In at least one example, already packaged DRAM stack or HBM DRAM can be used as stacks of memory dies 304. For example, Samsung offers HBM2 and HBM2E memory stacks, which deliver high bandwidth for high-performance computing and artificial intelligence tasks, or GDDR6 memory by Micron is commonly used in gaming and graphics applications, providing high data rates for performance-intensive workloads. Additionally, SK Hynix produces HBM2E stacks that may enhance efficiency for data-centric applications and utilizes TSVs for improved bandwidth. In at least one example, stack of memory dies 304 can have same type of memory dies (e.g., all DRAM or all HBM DRAM). In at least one example, a stack of memory dies 304 may have a combination of different types of memory dies.

The choice of a stack of memory dies 304 may not be limiting the scope of the disclosure. For example, the stack of memory dies may include a static random-access memory (SRAM) that may be useful in generative AI applications. In at least one example, SRAM provides rapid access to frequently used data, which may optimize performance during compute intensive AI workloads. For instance, when executing algorithms for training neural networks, SRAM may help reduce latency by ensuring that critical data is readily available. In at least one example, memory dies within a stack of memory dies 304 may be a flash memory. Although flash memory may not be stacked in the same way as DRAM (using TSVs) but can be made part of stack of memory dies 304 that may include both DRAM for fast access and flash memory for long-term storage, which can allow generative AI applications to efficiently manage data at different stages of processing.

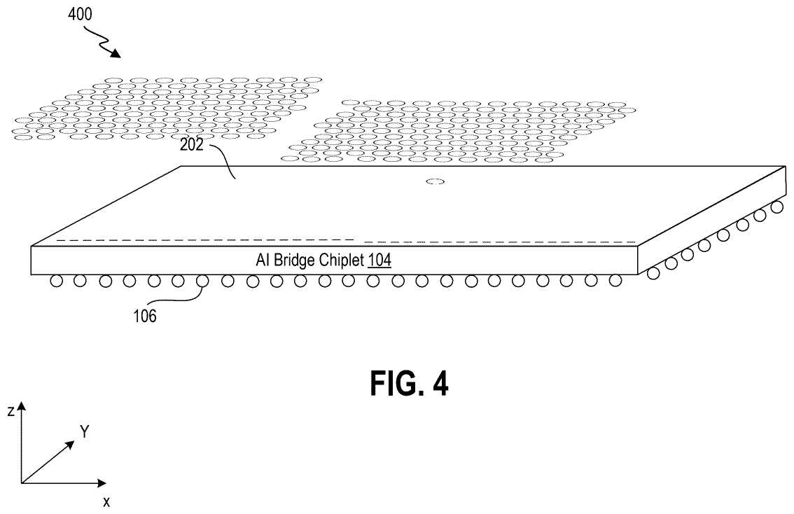

FIG. 4 is a schematic of an AI bridge chiplet with its top surface having pads for processor dies and stacks of memory dies and bottom surface having IO connections to bond with a substrate 102, in accordance with at least one example. At the top surface of an AI bridge chiplet 104, pads 202 are designed as also illustrated in FIG. 2. Pads 202 are designed as receiving patterns to facilitate secure attachment of a processor die 302 and a stack of memory dies 304. In at least one example, receiving patterns may be properly aligned to enable effective electrical connections with the underlying circuitry. In at least one example, the design of receiving patterns can vary, often featuring pads or grooves that can accommodate a specific shape and size of processor dies 302 and stacks of memory dies 304. In at least one example, pads 202 may be designed in such a way that pre-packaged or pre-made processor dies and stacks of memory dies 304 can be attached using pads 202. As a result, customize processor dies 302 and stacks of memory dies 304 may not be customized to a specific pad configuration, simplifying the integration process in a cost-effective manner. In at least one example, AI bridge chiplets 104 may allow for a greater compatibility, reducing time-to-market and lowering the overall costs associated with designing and fabricating specialized dies (e.g., processor dies 302 and stacks of memory dies 304).

On the bottom surface of an AI bridge chiplet 104, solder balls 106 or copper pillars may be used as interconnects to create a link between AI bridge chiplet 104 and substrate 102. In at least one example, copper pillars may be used as interconnects that can provide a solid mechanical and electrical connection. Copper pillars may offer advantages in terms of thermal and electrical conductivity. In at least one example, copper pillars may be more effective, particularly in high-density applications, as copper pillars can be designed to fit in a limited space as compared to traditional solder balls.

In at least one example, solder balls 106 may serve to connect AI bridge chiplet 104 to substrate 102. In at least one example, solder balls 106 may be used in many assembly techniques e.g., ball grid array (BGA) packaging. One such example is illustrated in FIG. 4, where the bottom surface of AI bridge chiplet 104 comprises solder balls to provide efficient communication and power distribution, while supporting thermal management in the overall assembly. In at least one example, solder balls 106 may serve as contact points that can allow electrical signals to flow between AI bridge chiplets 104 and substrate 102.

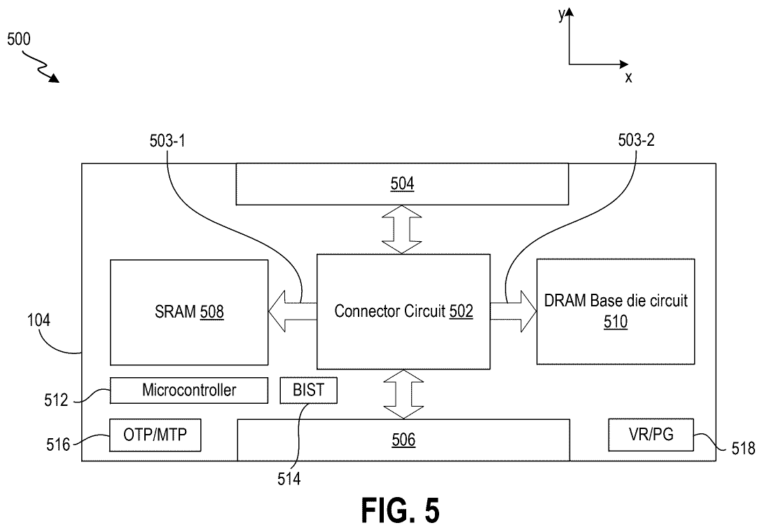

FIG. 5 is a schematic of a circuitry built inside an AI bridge chiplet 104, in accordance with at least one example. Circuitry 500 may be built inside AI bridge chiplet 104 and comprises a connector circuit 502, a first connector link 504 circuitry, a second connector link 506 circuitry, an SRAM 508, a DRAM base die circuit 510, a microcontroller 512, a built-in self-test circuitry (referred as BIST 514), a voltage regulator (VR) and/or power gating (PG) circuit (referred as VR/PG 518), or a one-time programmable memory and/or multi-time programmable memory (referred as OTP/MTP 516). In at least one example, AI bridge chiplet 104 may be a full chiplet that includes communication, control, and test circuitry, and it can serve as a stacking base die for processor die 302 and stack of memory dies 304.

In at least one example, connector circuit 502 can enable communication between different components of AI bridge chiplet 104 (e.g., processor die 302 and stack of memory dies 304). In at least one example, connector circuit 502 can also connect AI bridge chiplets 104 within an assembly of AI bridge chiplets to allow signals to pass through them. In at least one example, connector circuits 502 may create electrical connections between dies (e.g., processor dies 302 and stacks of memory dies 304) stacked on AI bridge chiplets 104, and between AI bridge chiplets 104, thereby integrating AI bridge chiplets 104 into a larger assembly. In at least one example, connector circuit 502 is a network-on-chip connector circuit (also referred to as an NoC connector circuit).

In at least one example, an NoC connector circuit forms a mini network that can allow multiple AI bridge chiplets 104 to communicate efficiently with adjacent neighbors of AI bridge chiplets 104. Each AI bridge chiplet 104 can have a connector circuit 502 (e.g., an NoC connector circuit) along with a first connector link circuitry 504 and a second connector link circuitry 506. In at least one example, first connector link circuitry 504 and second connector link circuitry 506 allow exchange of data and resources between adjacent neighboring AI bridge chiplets. In at least one example, first connector link circuitry 504 and second connector link circuitry 506 are network-on-chip connector link circuitries. In at least one example, first connector link circuitry 504 and second connector link circuitry 506 are die-to-die connector link circuitries. In at least one example, connector circuit 502 (e.g., NoC connector circuit) comprises of a switch, a router, and two interfaces: a first interface 503-1 and a second interface 503-2, which can be collectively referred to as interfaces 503 and can be individually referred to as interface 503.

In at least one example, one or more switches may be present in connector circuit 502. In at least one example, first interface 503-1 of connector circuit 502 can be used to communicate with processor die 302, and a second interface 503-2 of connector circuit 502 can be used to communicate with a stack of memory dies 304. In at least one example, the one or more switches of connector circuit 502 can provide full connectivity such that the switch can allow processor die 302 to access available memory address ranges of the stack of memory dies 304. In at least one example, the one or more switches of a connector circuit 502 can direct data packets to their intended destinations, which ensures that information can flow smoothly across AI bridge chiplet 104.

In at least one example, the router of connector circuit 502 can move data between other connector circuits of AI bridge chiplets 104, wherein connector circuits 502 can be NoC connector circuits. In at least one example, routers can determine the most efficient path for data packets based on traffic conditions and network topologies. For example, when a data packet arrives at a router, it analyzes the destination address and determines a path to forward the data packet to the next switch of connector circuit 502 or directly to destination connector circuit. In at least one example, one or more switches and routers provide full connectivity to a processor die 302 of an AI bridge chiplet 104 to enable its communication with a stack of memory dies 304 of another AI bridge chiplet without any restriction.

In at least one example, connector circuit 502 can reduce latency as data can be routed directly to a given target without unnecessary detours. In at least one example, connector circuit 502 can allow for effective load balancing. Connector circuit 502 can dynamically distribute data packets based on the current demand and processing needs. In at least one example, connector circuit 502 can provide faster access to shared resources. For example, connector circuit 502 may provide a processor die 302 access to the complete range of memory addresses of a stack of memory dies 304, increasing the utility of resources within AI bridge chiplet 104. Such an assembly of AI bridge chiplet 104 may provide scalability and allow for expansion in future without redesigning it significantly.

In at least one example, a first connector link circuitry 504 (also referred to as a first connector link 504) and a second connector link circuitry 506 (also referred to as a second connector link 506) comprises of a set of physical connections which may include wires or interconnects. In at least one example, first connector link 504 and second connector link 506 can provide high-bandwidth channel to enable faster data transfer rates. In at least one example, first connector link 504 and second connector link 506 may often be accompanied by a protocol for managing transfer of data using connector circuit 502. In at least one example, first connector link 504 and second connector link 506 may allow data packets to travel between AI bridge chiplets 104. For example, connector circuit 502 may encapsulate data in packets and then send it through first connector link 504 or second connector link 506. In at least one example, AI bridge chiplet 104 may have two NoC connector links. In at least one example, AI bridge chiplet 104 may have four NoC connector links.

In at least one example, SRAM 508 may be placed below a stacked processor die 302 of AI bridge chiplet 104. SRAM 508 may act as a local cache for processor die 302 and provide a high-speed buffer that can store frequently accessed data. In at least one example, SRAM 508 can deliver data in significantly less time compared to the stack of memory dies 304 (e.g., a DRAM stack) whenever processor die 302 requests data. SRAM 508 can, therefore, improve the overall response time of AI bridge chiplet 104.

In at least one example, DRAM base die circuit 510 may also be integrated in circuitry 500 for stacking memory dies 310. In at least one example, DRAM base die circuit 510 can manage communication between a stack of memory dies 304 (e.g., a DRAM stack or HBM DRAM) and a processor die 302 (e.g., CPU, GPU, NPU etc.). In at least one example, DRAM base die circuit 510 can handle input/output operations to provide efficient data transfer using communication protocols. In at least one example, DRAM base die circuit 510 comprises an input/output interface (also referred to as I/O interface) that can translate electrical signals from e.g., DRAM cells into usable data formats for a processor die 302. I/O interface can minimize latency and maximize bandwidth that may allow for faster reads and writes, enabling complex computations that are typically used in generative AI. In at least one example, DRAM base die circuit 510 can manage power distribution, signal integrity and interconnects among stacked dies. In at least one example, DRAM base die circuit 510 can support multiple memory dies e.g., DRAMs, HBMs, HBM DRAMs or the like.

In at least one example, DRAM base die circuit 510 and SRAM 508 create a balanced memory hierarchy such that DRAM 510 can handle larger volumes of data storage while SRAM 508 can ensure faster access to critical data. In at least one example, AI bridge chiplets 104 may integrate various functions (e.g., processing, memory, I/O) using a microcontroller 512 that can manage and coordinate the functions across an AI bridge chiplet 104. In at least one example, microcontrollers 512 may oversee communications between AI bridge chiplets 104 for smooth flow of data. Microcontrollers 512 can handle tasks e.g., initializing AI bridge chiplets 104, managing their power states, and coordinate using data transfer protocols. In at least one example, microcontroller 512 may act as a central control unit for AI bridge chiplet 104, which may enhance the system performance, and optimize how resources may be allocated and used. In at least one example, microcontroller 512 monitors performance of AI bridge chiplet 104 and diagnoses faults by running debugging and testing processes.

In at least one example, BIST circuitry 514 may also be present in an AI bridge chiplet 104. BIST circuitry 514 can automatically verify that all routing connections between AI bridge chiplets 104 are intact. This ensures that each AI bridge chiplet 104 is properly integrated within an assembly of AI bridge chiplets. In at least one example, BIST circuitry 514 can initiate a series of tests to assess the status of connections and communication pathways between AI bridge chiplets 104, and verify whether that data can be correctly transmitted and received between chiplets 104 by analyzing the electrical integrity of interconnects. By executing the tests, BIST circuitry 514 can identify faults e.g., short circuits or open connections that may compromise performance of AI bridge chiplets 104 which ultimately lead to failures.

Additionally, one component of circuitry 500 can be a one-time programmable memory and/or multi-time programmable memory referred to as OTP/MTP 516. In at least one example, OTP/MTP 516 may define how data can be stored and/or utilized within an assembly of AI bridge chiplets. In at least one example, OTP memory allows data to be written once and it may not be modified afterwards. OTP memory is useful to store critical configuration settings, unique identifiers, or security keys that may need to remain constant throughout the lifetime of AI bridge chiplet 104. In contrast, MTP memory data can be changed to account for configuration changes or application-specific adaptations after AI bridge chiplet 104 is manufactured. In at least one example, MTP may prove useful in applications where updates or adjustments may be needed without replacing an entire AI bridge chiplet. In at least one example, OTP/MTP 516 may help in providing various functions (e.g., configuration, calibration, and security management) to cater to specific needs of different generative AI applications.

In at least one example, VR/PG 518 is integrated within AI bridge chiplet 104 to manage power delivery and provide reliable operations of various components of AI bridge chiplet 104 (including different components that are present inside circuitry 500 and components or dies stacked on AI bridge chiplet 104). In at least one example, voltage regulator circuitry of VR/PG 518 may convert input voltage to the appropriate levels used by different components of AI bridge chiplet 104. Voltage regulator circuitry of VR/PG 518 may also regulate the voltage levels to prevent fluctuations or surges, which may lead to unreliable performance, overheating, or even damage AI bridge chiplets 104. In at least one example, voltage regulators within the VR/PG 518 may use feedback mechanisms to monitor the output voltage and dynamically adjust the output voltage levels to meet desired voltage levels.

In at least one example, power gates within VR/PG 518 control power supply to various parts of AI bridge chiplet 104. Power gating circuitry reduces power consumption by turning off power to sections or components of AI bridge chiplet that may not be in use. In at least one example, power gating circuitry within VR/PG 518 can use transistors as switches. For example, when a particular module (or circuit) of AI bridge chiplet 104 is not in use, the power gating circuitry disconnects the power supply to the module (or circuit). When the module (or circuit) is needed, the power gating circuitry turns on the switch by restoring power to the module (or circuit). In at least one example, the power gating circuitry reduces static power consumption, reducing the amount of heat generated.

Due to the integration of components built inside AI bridge chiplet 104, AI bridge chiplets 104 can provide several functions including: (a) bridging a processor die 302 and stack of memory dies 304 via connector circuit 502; (b) enabling connectivity between processor die 302 and stack of memory dies 304 using a switch; (c) interconnectivity between various AI bridge chiplets through a connector link circuitry coupled to connector circuit 502; (d) testing using BIST 514 circuitry; (e) bootup sequencing by a microcontroller 512; and/or (f) voltage regulation and power gating.

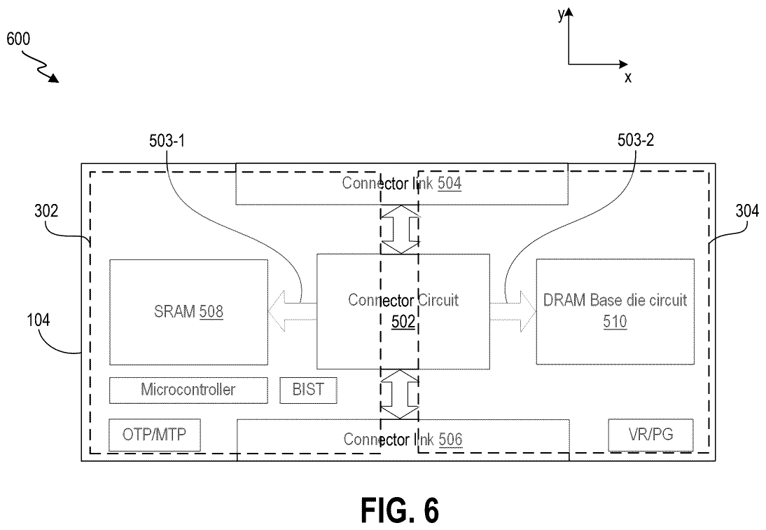

FIG. 6 is a schematic of a circuitry 600 inside an AI bridge chiplet 104 in which a connector circuit is used to bridge a processor die and a stack of memory dies, in accordance with at least one example. In at least one example, circuitry 600 focuses on the placement of a processor die 302 and a stack of memory dies 304 on AI bridge chiplet 104, wherein components of circuitry 600 are within AI bridge chiplet 104 as discussed in FIG. 5. In at least one example, processor die 302 may be positioned above SRAM 508. SRAM 508 may act as a local cache for processor die 302 and provide a high-speed buffer that can store frequently accessed data. Furthermore, stack of memory dies 304 may be stacked over the section of AI bridge chiplet 104 where DRAM base die circuit 510 may be located. DRAM base die circuit 510 can provide efficient and high-speed data access and communication between stacked memory dies 304.

In at least one example, processor die 302 and stack of memory dies 304 are vertically adjacent to a connector circuit 502 which bridges processor die 302 and stack of memory dies 304 via a first interface 503-1 and a second interface 503-2. In at least one example, first interface 503-1 of connector circuit 502 can be used to communicate with processor die 302, and second interface 503-2 of connector circuit 502 can be used to communicate with stack of memory dies 304 via DRAM base die circuit 510. In at least one example, one or more switches within connector circuit 502 can provide full connectivity such that the switch can allow a processor die 302 to access available memory address ranges of stack of memory dies 304. In at least one example, first interface 503-1 and second interface 503-2 may provide high bandwidth communication, e.g., greater than 1 GHz, between processor die 302 and stack of memory dies 304 via connector circuit 502.

In at least one example, connector circuit 502 may provide a high-bandwidth memory (HBM) link between processor die 302 and stack of memory dies 304 (e.g., a HBM DRAM). HBM link may access large memory pools that can reduce latency in data-intensive applications (e.g., generative AI). In at least one example, first connector link 504 and second connector link 506 are also coupled to connector circuit 502. In at least one example, first connector link 504 and second connector link 506 may enable neighboring AI bridge chiplets to communicate with processor die 302 and/or stack of memory dies 304 of associated AI bridge chiplet 104. In at least one example, processor die 302 of AI bridge chiplet 104 may communicate with a stack of memory dies 304 of another AI bridge chiplet via first connector link 504 or second connector link 506.

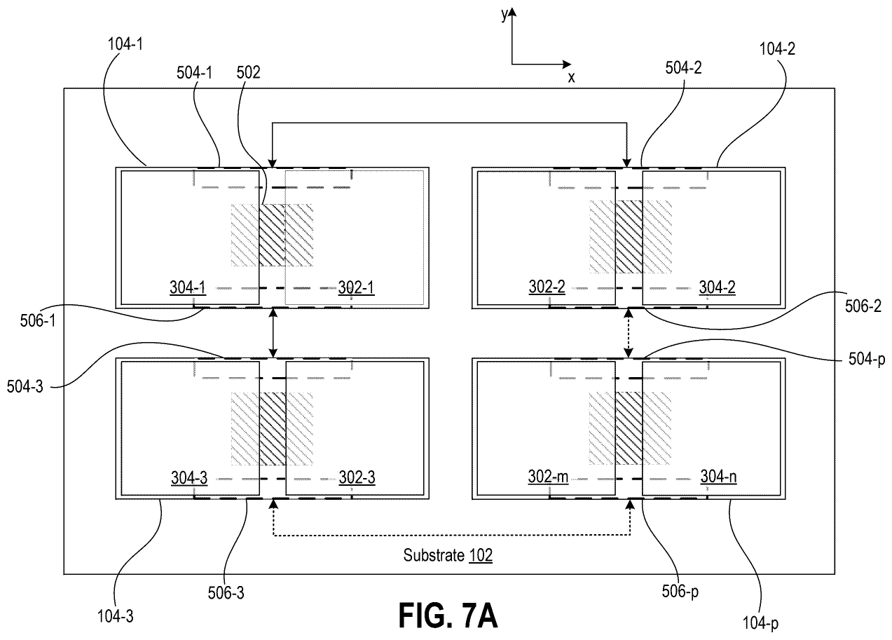

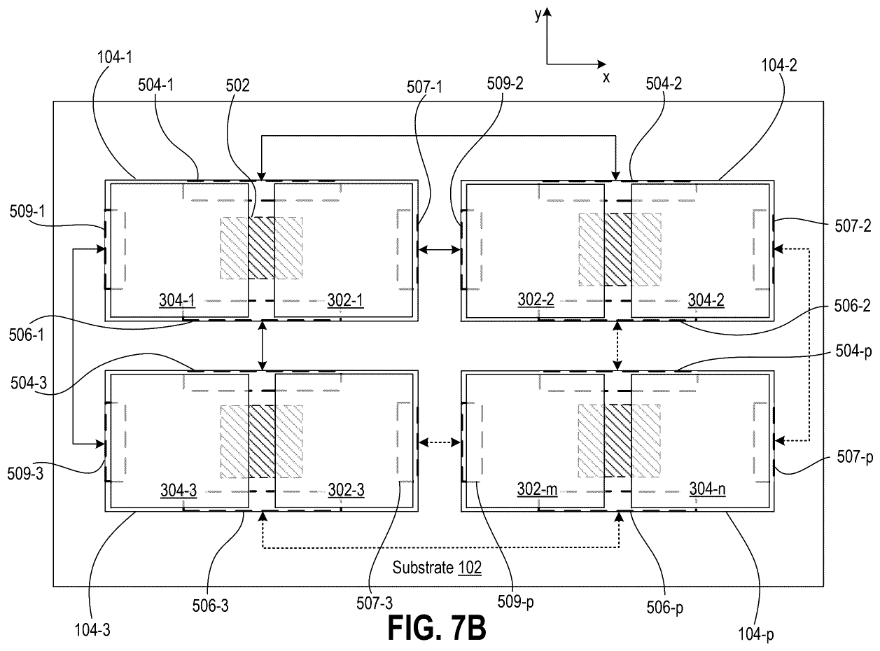

FIG. 7A is a schematic illustrating a top view of an assembly of AI bridge chiplets on a substrate 102 with processor dies and stacks of memory dies bridged via connector circuits, wherein the AI bridge chiplets are connected in a ring configuration, in accordance with at least one example. Here “ring configuration” generally refers to a type of network topology in which each device, chiplet, or node is connected to exactly two other nodes, forming a circular structure. In this configuration, data travels in one direction in the ring, or in some configurations, in both directions, allowing for bidirectional communication. In a network with n nodes, each node can send and receive data directly from its two neighboring nodes. This setup creates a simple yet efficient pathway for data transmission, enabling each device to communicate without a need for a central hub or switch. One of the benefits of the ring configuration is its scalability e.g., adding or removing nodes can be done relatively easily without disrupting the functions of the overall network. Additionally, direct connections enable communication between neighboring nodes, leading to a lower latency in comparison to other topologies.

One such example is illustrated in FIG. 7A, where AI bridge chiplets 104-1, 104-2, 104-3, . . . , 104-p are assembled over substrate 102 forming a ring configuration. AI bridge chiplets 104 comprise connector circuits 502 that can be coupled with NoC connector link circuitry (e.g., first connector link 504 and second NoC connector link 506) as shown in FIG. 5. Connector circuits 502 may be partially under processor dies 302 and stacks of memory dies 304 and can provide an interface (e.g., first interface 503-1 and second interface 503-2) that bridges processor dies 302 and stacks of memory dies 304. In at least one example, connector circuit 502 and connector links of an AI bridge chiplet 104 may be used to communicate with neighboring AI bridge chiplets 104, forming a ring configuration. In at least one example, each AI bridge chiplet can communicate in two directions e.g., north and south.

In at least one example, a first connector link 504-1 of AI bridge chiplet 104-1 is connected to a first connector link 504-2 of AI bridge chiplet 104-2, and a second connector link 506-1 of AI bridge chiplet 104-1 is connected to a first connector link 504-3 of AI bridge chiplet 104-3. Similarly, a second connector link 506-2 of AI bridge chiplet 104-2 is connected to a first connector link 504-p of AI bridge chiplet 104-p, and a second connector link 506-3 of AI bridge chiplet 104-3 is connected with a second connector link 506-p of AI bridge chiplet 104-p. Herein, AI bridge chiplets 104 are connected in a ring configuration. In at least one example, two AI bridge chiplets can form a ring configuration. In at least one example, four AI bridge chiplets can form a ring configuration. In at least one example, any number of AI bridge chiplets 104 can form a ring configuration.

FIG. 7B is a schematic illustrating a top view of an assembly of AI bridge chiplets on a substrate with processor dies and stacks of memory dies bridged via connector circuits, wherein the AI bridge chiplets are connected in a grid configuration, in accordance with at least one example. Here “grid configuration” generally refers to a type of network topology in which nodes are arranged in a two-dimensional grid-like structure, allowing for efficient data communication and resource sharing among connected devices. In this arrangement, each node is connected to its immediate neighbors both horizontally and vertically. The grid configuration layout may enable multiple paths for data transmission and enhance the robustness, reliability, and flexibility of the system. One of the advantages of a grid configuration is its scalability. New nodes can be easily added to a grid without significantly disrupting the existing grid structure. This flexibility makes grid configurations suitable for applications requiring dynamic expansion, such as large-scale data centers or generative AI. Additionally, the availability of multiple connection paths can help in reducing bottlenecks by improving load balancing of data and optimizing data flows.

One such example is illustrated in FIG. 7B, in which AI bridge chiplets 104-1, 104-2, 104-3, . . . , 104-p are assembled over a substrate 102 forming a grid configuration. AI bridge chiplets 104 comprise connector circuits 502 that can be coupled with NoC connector link circuitries e.g., a set of first connector links 504-1, 504-2, 504-3, . . . , 504-p, a set of second connector links 506-1, 506-2, 506-3, . . . , 506-p, a set of third connector links 507-1, 507-2, 507-3, . . . , 507-p and a set of fourth connector links 509-1, 509-2, 509-3, . . . , 509-p. In at least one example, a first connector link 504-1 of AI bridge chiplet 104-1 is connected to a first connector link 504-2 of AI bridge chiplet 104-2, and a third connector link 507-1 of AI bridge chiplet 104-1 is connected to a fourth connector link 509-2 of AI bridge chiplet 104-2. Additionally, a second connector link 506-1 of AI bridge chiplet 104-1 is connected to a first connector link 504-3 of AI bridge chiplet 104-3, and a fourth connector link 509-1 of AI bridge chiplet 104-1 is connected to a fourth connector link 509-3 of AI bridge chiplet 104-3. Similarly, AI bridge chiplet 104-2 and AI bridge chiplet 104-3 are connected with AI bridge chiplet 104-p, wherein each AI bridge chiplet 104 can have four interconnect links with the two adjacent neighboring AI bridge chiplets. Herein, AI bridge chiplets 104 are connected in a grid configuration. In at least one example, two AI bridge chiplets can form a grid configuration. In at least one example, four AI bridge chiplets can form a grid configuration. In at least one example, any number of AI bridge chiplets 104 can form a grid configuration.

In at least one example, connector circuit 502 of AI bridge chiplet 104 can enable communication in four directions e.g., north, south, east, and west. By enabling connections in four directions, connector circuit 502 can ensure that any processor die 302 of an AI bridge chiplet 104 can quickly access memory from a stack of memory dies 304 of another AI bridge chiplet 104 regardless of the physical placement of processor die 302 or stack of memory dies 304. In at least one example, additional AI bridge chiplets can be integrated into an assembly of AI bridge chiplets without compromising overall system performance, as connector circuits 502 can manage the increased data traffic in multiple directions. In at least one example, communication in four directions can enhance redundancy and fault tolerance, thereby improving the scalability of the system.

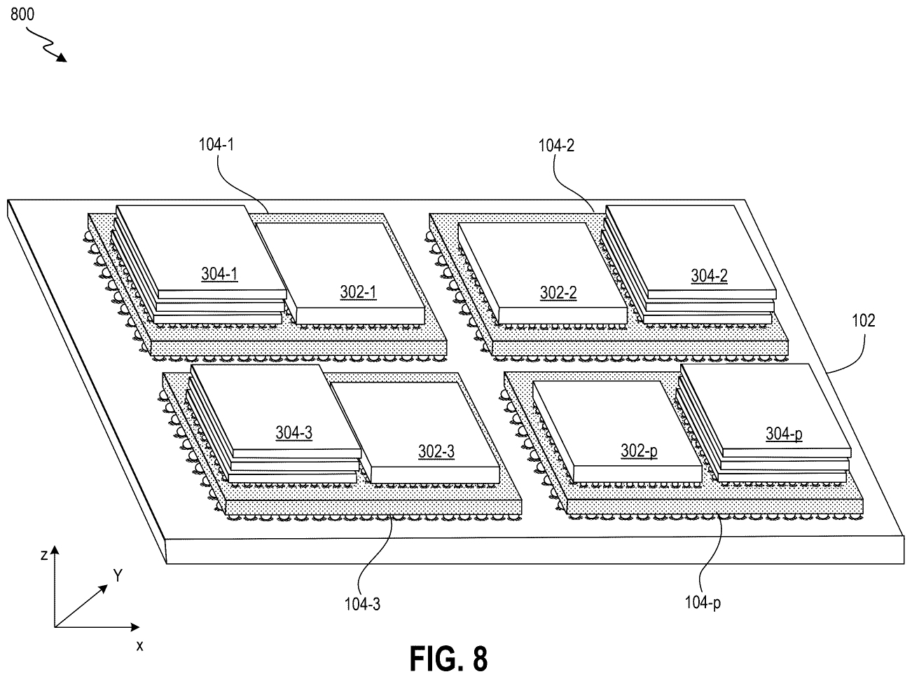

FIG. 8 is a schematic showing an isometric view of an assembly of AI bridge chiplets 800 on a substrate with processor dies and stacks of memory dies, in accordance with at least one example. The isometric view of the assembly of AI bridge chiplets 800 represents a layered architecture, starting with a substrate 102 as a foundation layer, followed by a modular layer comprising AI bridge chiplets 104 that is followed by dies (e.g., processor dies 302 and stacks of memory dies 304). In at least one example, AI bridge chiplets 104 can be interconnected through high-speed data pathways or interconnects. The high-speed interconnects can be integrated into substrate 102. In at least one example, interconnects can allow for fast data exchange between AI bridge chiplets 104 that may minimize latency in processing tasks. In at least one example, substrate 102 isolates AI bridge chiplets 104 to prevent unintended signal interference.

In at least one example, an AI bridge chiplet may be designed to tailor generative AI tasks. In at least one example, two AI bridge chiplets can be mounted on a substrate. In at least one example, four AI bridge chiplets can be mounted on a substrate. In at least one example, any number of AI bridge chiplets can be mounted on a substrate. One such example is illustrated in FIG. 8, where p number of AI bridge chiplets are mounted on a substrate 102. AI bridge chiplets can be added or removed based on the use cases of systems. In at least one example, AI bridge chiplets 104 make it easier to scale by increasing the size of the underlying carrier (e.g., substrate) and mounting additional AI bridge chiplets. In at least one example, scaling can be done in the x-dimension and/or y-dimension.

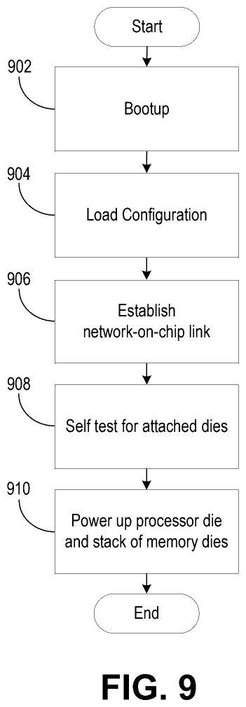

FIG. 9 is a flowchart of a bootup sequence for an AI bridge chiplet within an assembly of AI bridge chiplets, in accordance with at least one example. The various blocks of flowchart 900 can be performed by hardware, software, or a combination of them. While the blocks are shown in a particular order, the order can be modified. For instance, some blocks may be performed before others or simultaneously. At block 902, microcontroller 512 powers up an AI bridge chiplet 104. In at least one example, AI bridge chiplet 104 may activate power management units e.g., VR/PG 518, to supply necessary power to the circuitries built inside AI bridge chiplet 104. Bootup may also ensure that processor die 302 may become ready to execute tasks.

At block 904, AI bridge chiplet 104 may load configurations that optimize the circuitries for generative AI workloads. In at least one example, AI bridge chiplets read configuration settings from a local cache (e.g., an SRAM 508) or non-volatile memory. The configuration settings may include activation functions, precision settings, specific configurations for deep learning tasks, etc.

At block 906, AI bridge chiplets 104 establishes communication through NoC connector links that are coupled to connector circuits 502, which may be useful for AI workloads that often require high bandwidth and low latency. In at least one example, AI bridge chiplets 104 can configure internal data pathways and routing algorithms to facilitate communication between processor dies 302, stack of memory dies 304, and/or I/O interfaces. In at least one example, processor die 302 can communicate with AI bridge chiplet 104 to verify that processor die 302 can access the allocated stack of memory dies.

At block 908, AI bridge chiplets 104 may send signals to attached dies e.g., processor die 302 to initiate a self-test routine tailored for generative AI applications. In at least one example, many built-in self-tests may be run by the BIST circuitry 514 to check the functionality and performance of the system. In at least one example, AI bridge chiplet 104 may ensure that the data pathways between processor dies 302 can handle the expected throughput by sending many data packets and measuring latency and error rates. In at least one example, AI bridge chiplet 104 can execute known matrix multiplications to validate that processor die 302 can perform calculations correctly and return accurate results.

At block 910, AI bridge chiplet 104 may power up processor die 302 and stack of memory dies 304, after self-test routines are completed and validated. In at least one example, AI bridge chiplet 104 may hand over the control to processor die 302. Processor die 302 may be initialized by setting up frameworks and libraries required for executing generative AI tasks.

Here, “device,” “node,” or “unit” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus, which comprises the device.

Throughout the specification and in the claims, the term “connected” or “connection” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “adjacent” here generally refers to a position of a thing being next to (e.g., immediately next to or close to with one or more things between them) or adjoining another thing (e.g., abutting it).

The term “signal lines” or “wires” here generally refers to conductive pathways that facilitate transmission of data and control signals between different components (e.g., chiplets, processing cores or multi-core processors). Each signal line or wire can represent a single bit of information, or can be grouped together to form a bus to transmit multiple bits simultaneously.

The term “circuit” or “module” may refer to one or more passive and/or active components that are arranged to cooperate with one another to provide a desired function.

The term “signal” may refer to at least one current signal, voltage signal, magnetic signal, or data/clock signal. The meaning of “a,” “an,” and “the” include plural references. The meaning of “in” includes “in” and “on.”

The term “scaling” generally refers to converting a design (schematic and layout) from one process technology to another and subsequently reducing the layout area. It also refers to downsizing layouts and devices within the same technology node. Additionally, “scaling” may involve adjusting (e.g., slowing down or speeding up—i.e., scaling down or scaling up, respectively) a signal frequency relative to another parameter, such as power supply level. Scaling up can also mean adding more components, which can occur in the x-dimension or y-dimension enhancing functionality and overall performance.

The term “x-dimension” generally refers to the horizontal axis in a two-dimensional plane, typically representing the width or length of a device or layout. In the context of semiconductor design or electronic devices, it denotes the lateral arrangement of components, such as transistors, interconnects, or other elements, across the surface of a chip or a device.

The term “y-dimension” generally refers to vertical axis in a two-dimensional plane, typically representing the height of a device or layout. In semiconductor design or electronic devices, it indicates the arrangement of components stacked or layered on top of each other.

The terms “substantially,” “close,” “approximately,” “near,” and “about” generally refer to being within +/−10% of a target value. For example, unless otherwise specified in the explicit context of their use, the terms “substantially equal,” “about equal,” and “approximately equal” mean that there is no more than incidental variation between among things so described. In the art, such variation is typically no more than +/−10% of a predetermined target value.

Unless otherwise specified the use of the ordinal adjectives “first,” “second,” and “third,” etc., to describe a common object merely indicate that different instances of like objects are being referred to and are not intended to imply that the objects so described must be in a given sequence, either temporally, spatially, in ranking, or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures, or materials within a device, where such physical relationships are noteworthy. These terms are employed herein for descriptive purposes only and predominantly within the context of a device z-axis and therefore may be relative to an orientation of a device.

Reference in the specification to “an example,” “one example,” “some examples,” or “other examples” means that a particular feature, structure, or characteristic described in connection with the examples is included in at least some examples, but not necessarily all examples. The various appearances of “an example,” “one example,” or “some examples” are not necessarily all referring to the same examples. If the specification states that a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more examples. For example, a first example may be combined with a second example anywhere the particular features, structures, functions, or characteristics associated with the two examples are not mutually exclusive.

While the disclosure has been described in conjunction with specific examples thereof, many alternatives, modifications and variations of such examples will be apparent to those of ordinary skill in the art in light of the foregoing description. The examples of the disclosure are intended to embrace all such alternatives, modifications, and variations as to fall within the broad scope of the appended claims.

In addition, well-known power/ground connections to IC chips and other components may or may not be shown within the presented figures, for simplicity of illustration and discussion, and so as not to obscure the disclosure. Further, arrangements may be shown in block diagram form to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth to describe examples of the disclosure, it should be apparent to one skilled in the art that the disclosure can be practiced without, or with variation of, these specific details. The description is thus to be regarded as illustrative instead of limiting.

The structures of various examples described herein can also be described as method(s) of forming those structures or apparatuses, and method(s) of operation of these structures or apparatuses. Following are examples that illustrate the various examples of the disclosure. The examples can be combined with other examples. As such, various examples can be combined with other examples without changing the scope of the invention.

Example 1 is a first bridge apparatus comprising: a connector circuit having a first interface to communicate with a processor die and a second interface to communicate with a stack of memory dies, wherein the processor die and the stack of memory dies are vertically adjacent to the connector circuit which bridges the processor die and the stack of memory dies; a first connector link circuitry coupled to the connector circuit, wherein the first connector link circuitry is to communicate with a third connector link of a second bridge apparatus; and a second connector link circuitry coupled to the connector circuit, wherein the second connector link circuitry is to communicate with a fourth connector link of a third bridge apparatus.

Example 2 is a first bridge apparatus according to any example herein, in particular example 1, wherein the first bridge apparatus further comprises pads to connect the processor die and the stack of memory dies, wherein the first bridge apparatus has a top surface and a bottom surface opposite the top surface, wherein the pads are on the top surface, wherein the bottom surface comprises copper pillars or solder balls to connect to a substrate.

Example 3 is a first bridge apparatus according to any example herein, in particular example 1, wherein the connector circuit is a network-on-chip connector circuit.

Example 4 is a first bridge apparatus according to any example herein, in particular example 1, wherein the connector circuit of the first bridge apparatus further comprises routers and switches.

Example 5 is a first bridge apparatus according to any example herein, in particular example 1, wherein the first connector link circuitry and the second connector link circuitry are network-on-chip connector links.

Example 6 is a first bridge apparatus according to any example herein, in particular example 1, wherein the first interface and the second interface provide high bandwidth communication greater than 1 GHz between the processor die and the stack of memory dies via the connector circuit.

Example 7 is a first bridge apparatus according to any example herein, in particular example 1, wherein the first bridge apparatus further includes one or more of: a cache, a microcontroller, a built-in self-check circuit, a voltage regulator, and/or a power gate.

Example 8 is a first bridge apparatus according to any example herein, in particular example 1, wherein the first bridge apparatus is coupled with the second bridge apparatus and the third bridge apparatus in a ring configuration or a grid configuration.

Example 9 is an apparatus comprising: a substrate; processor dies including a first processor die and a second processor die; stacks of memory dies including a first stack of memory dies and a second stack of memory dies; a first bridge apparatus on the substrate; and a second bridge apparatus on the substrate, wherein the first bridge apparatus comprises: a first connector circuit having a first interface to communicate with the first processor die and a second interface to communicate with a first stack of memory dies, wherein the first processor die and the first stack of memory dies are vertically adjacent to the first connector circuit that bridges the first processor die and the first stack of memory dies; a first connector link circuitry coupled to the first connector circuit, wherein the first connector link circuitry is to communicate with a first connector link of a second bridge apparatus; and a second connector link circuitry coupled to the first connector circuit, wherein the second connector link circuitry is to communicate with a second connector link of the second bridge apparatus; wherein the second bridge apparatus comprises: a second connector circuit having a first interface to communicate with the second processor die and a second interface to communicate with the second stack of memory dies, wherein the second processor die and the second stack of memory dies are vertically adjacent to the second connector circuit which bridges the second processor die and the second stack of memory dies; a first connector link circuitry coupled to the second connector circuit; and a second connector link circuitry coupled to the second connector circuit.

Example 10 is an apparatus according to any example herein, in particular example 9, wherein the first bridge apparatus and the second bridge apparatus further comprise pads to connect the processor dies and the stacks of memory dies, wherein the first bridge apparatus and the second bridge apparatus have top surfaces and bottom surfaces opposite to the top surfaces, wherein the pads are on the top surfaces, wherein the bottom surfaces comprise copper pillars or solder balls to connect to the substrate.

Example 11 is an apparatus according to any example herein, in particular example 9, wherein the first connector circuit and the second connector circuit are network-on-chip connector circuits.

Example 12 is an apparatus according to any example herein, in particular example 9, wherein the first connector circuit and the second connector circuit further comprise routers and switches.

Example 13 is an apparatus according to any example herein, in particular example 9, wherein the first connector link circuitry and the second connector link circuitry of the first bridge apparatus and the second bridge apparatus are network-on-chip connector links.

Example 14 is an apparatus according to any example herein, in particular example 9, wherein the first bridge apparatus and the second bridge apparatus further include one or more of: caches, microcontrollers, built-in self-check circuits, voltage regulators and/or power gates.

Example 15 is an apparatus according to any example herein, in particular example 9, wherein the first bridge apparatus and the second bridge apparatus are connected in a ring configuration, a star configuration, or a grid configuration.

Example 16 is an apparatus comprising: a substrate; and a first bridge apparatus on the substrate, wherein the first bridge apparatus comprises: a first connector circuit having a first interface to communicate with a processor die and a second interface to communicate with a stack of memory dies, wherein the processor die and the stack of memory dies are vertically adjacent to the first connector circuit which bridges the processor die and the stack of memory dies; a first connector link circuitry coupled to the first connector circuit, wherein the first connector link circuitry is to communicate with a first connector link of a second bridge apparatus; a second connector link circuitry coupled to the first connector circuit, wherein the second connector link circuitry is to communicate with a second connector link of the second bridge apparatus; a third connector link circuitry coupled to the first connector circuit, wherein the third connector link circuitry is to communicate with a first connector link of a third bridge apparatus; and a fourth connector link circuitry coupled to the first connector circuit, wherein the fourth connector link circuitry is to communicate with a fourth connector link of the third bridge apparatus.

Example 17 is an apparatus according to any example herein, in particular example 16, wherein the first connector circuit is a network-on-chip connector circuit.

Example 18 is an apparatus according to any example herein, in particular example 16, wherein the first connector circuit is to communicate in any orientation from north-to-south or east-to-west.

Example 19 is an apparatus according to any example herein, in particular example 16, wherein the first connector link circuitry, the second connector link circuitry, the third connector link circuitry, and the fourth connector link circuitry of the first bridge apparatus are network-on-chip connector links.

Example 20 is an apparatus according to any example herein, in particular example 16, wherein the first bridge apparatus is coupled with the second bridge apparatus and the third bridge apparatus in a grid configuration.

What is claimed is:

1. A first bridge apparatus comprising:
a connector circuit having a first interface to communicate with a processor die and a second interface to communicate with a stack of memory dies, wherein the processor die and the stack of memory dies are vertically adjacent to the connector circuit which bridges the processor die and the stack of memory dies;
a first connector link circuitry coupled to the connector circuit, wherein the first connector link circuitry is to communicate with a third connector link of a second bridge apparatus; and
a second connector link circuitry coupled to the connector circuit, wherein the second connector link circuitry is to communicate with a fourth connector link of a third bridge apparatus.

2. The first bridge apparatus of claim 1 further comprises pads to connect the processor die and the stack of memory dies, wherein the first bridge apparatus has a top surface and a bottom surface opposite the top surface, wherein the pads are on the top surface, wherein the bottom surface comprises copper pillars or solder balls to connect to a substrate.

3. The first bridge apparatus of claim 1, wherein the connector circuit is a network-on-chip connector circuit.

4. The first bridge apparatus of claim 1, wherein the connector circuit of the first bridge apparatus further comprises a router and a switch.

5. The first bridge apparatus of claim 1, wherein the first connector link circuitry and the second connector link circuitry are network-on-chip connector links.

6. The first bridge apparatus of claim 1, wherein the first interface and the second interface provide high bandwidth communication greater than 1 GHz between the processor die and the stack of memory dies via the connector circuit.

7. The first bridge apparatus of claim 1, wherein the first bridge apparatus further includes one or more of: a cache, a microcontroller, a built-in self-check circuit, a voltage regulator, and/or a power gate.

8. The first bridge apparatus of claim 1, wherein the first bridge apparatus is coupled with the second bridge apparatus and the third bridge apparatus in a ring configuration or a grid configuration.

9. An apparatus comprising:
a substrate;
processor dies including a first processor die and a second processor die;
stacks of memory dies including a first stack of memory dies and a second stack of memory dies;
a first bridge apparatus on the substrate; and
a second bridge apparatus on the substrate, wherein the first bridge apparatus or the second bridge apparatus comprises:
a first connector circuit having a first interface to communicate with the first processor die and a second interface to communicate with a first stack of memory dies, wherein the first processor die and the first stack of memory dies are vertically adjacent to the first connector circuit that bridges the first processor die and the first stack of memory dies;
a first connector link circuitry coupled to the first connector circuit, wherein the first connector link circuitry is to communicate with a first connector link of the second bridge apparatus; and
a second connector link circuitry coupled to the first connector circuit, wherein the second connector link circuitry is to communicate with a second connector link of the second bridge apparatus; wherein the second bridge apparatus comprises:
a second connector circuit having a first interface to communicate with the second processor die and a second interface to communicate with the second stack of memory dies, wherein the second processor die and the second stack of memory dies are vertically adjacent to the second connector circuit which bridges the second processor die and the second stack of memory dies;
a first connector link circuitry coupled to the second connector circuit; and
a second connector link circuitry coupled to the second connector circuit.

10. The apparatus of claim 9, wherein the first bridge apparatus and the second bridge apparatus further comprise pads to connect the processor dies and the stacks of memory dies, wherein the first bridge apparatus and the second bridge apparatus have top surfaces and bottom surfaces opposite to the top surfaces, wherein the pads are on the top surfaces, wherein the bottom surfaces comprise copper pillars or solder balls to connect to the substrate.

11. The apparatus of claim 9, wherein the first connector circuit and the second connector circuit are network-on-chip connector circuits.

12. The apparatus of claim 9, wherein the first connector circuit and the second connector circuit further comprise routers and switches.

13. The apparatus of claim 9, wherein the first connector link circuitry and the second connector link circuitry of the first bridge apparatus and the second bridge apparatus are network-on-chip connector links.

14. The apparatus of claim 9, wherein the first bridge apparatus and the second bridge apparatus further include one or more of: caches, microcontrollers, built-in self-check circuits, voltage regulators and/or power gates.

15. The apparatus of claim 9, wherein the first bridge apparatus and the second bridge apparatus are connected in a ring configuration or a grid configuration.

16. An apparatus comprising:
a substrate; and
a first bridge apparatus on the substrate, wherein the first bridge apparatus comprises:
a first connector circuit having a first interface to communicate with a processor die and a second interface to communicate with a stack of memory dies, wherein the processor die and the stack of memory dies are vertically adjacent to the first connector circuit which bridges the processor die and the stack of memory dies;
a first connector link circuitry coupled to the first connector circuit, wherein the first connector link circuitry is to communicate with a first connector link of a second bridge apparatus;
a second connector link circuitry coupled to the first connector circuit, wherein the second connector link circuitry is to communicate with a second connector link of the second bridge apparatus;
a third connector link circuitry coupled to the first connector circuit, wherein the third connector link circuitry is to communicate with a first connector link of a third bridge apparatus; and
a fourth connector link circuitry coupled to the first connector circuit, wherein the fourth connector link circuitry is to communicate with a fourth connector link of the third bridge apparatus.

17. The apparatus of claim 16, wherein the first connector circuit is a network-on-chip connector circuit.

18. The apparatus of claim 16, wherein the first connector circuit is to communicate in any orientation from north-to-south or east-to-west.

19. The apparatus of claim 16, wherein the first connector link circuitry, the second connector link circuitry, the third connector link circuitry, and the fourth connector link circuitry of the first bridge apparatus are network-on-chip connector links.

20. The apparatus of claim 16, wherein the first bridge apparatus is coupled with the second bridge apparatus and the third bridge apparatus in a grid configuration.
